(19) United States
(12) Patent Application Publication
(10) Pub. No.: US 2014/0163768 A1
(43) Pub. Date: Jun. 12, 2014

(54) EVENT AND CONDITION DETERMINATION BASED ON SENSOR DATA

(71) Applicant: AT&T INTELLECTUAL PROPERTY I, L.P., Atlanta, GA (US)

(72) Inventors: Kermit Hal Purdy, Bernardsville, NJ (US); Brian S. Amento, Morris Plains, NJ (US); Brian Greaves, Atlanta, GA (US); Kevin Ansia Li, Chatham, NJ (US); Larry Stead, Upper Montcla, NJ (US)

(73) Assignee: AT&T INTELLECTUAL PROPERTY I, L.P., Atlanta, GA (US)

(21) Appl. No.: 13/711,020

(22) Filed: Dec. 11, 2012

(51) Int. Cl. G06F 17/00

(52) U.S. Cl. CPC G06F 17/00
USPC 701/1

(57) ABSTRACT

Sensors on vehicles may be used to automatically obtain data about events and conditions pertaining to vehicles. The data may be automatically provided to a server, third party, agency, subscriber, a vehicle, a driver, or the like. In example embodiments, data may be obtained regarding vehicles pertaining to, for example, location, braking, acceleration, turning, stopping, speed, direction, video data (e.g., via a camera on the vehicle), tire pressure, depth, or the like, or any appropriate combination thereof. The obtained data may aggregated. The aggregated data may be utilized to determine if events related to the vehicle are occurring and to determine a condition associated with the event.

### TECHNICAL FIELD

The technical field generally relates to communications systems and more specifically relates to determine events and condition based on sensor data.

### BACKGROUND

There are a myriad of situations in which it would be helpful to know what lies ahead or to know the conditions at an upcoming location. Vehicular drivers could benefit from knowing the conditions near a vehicle's current location or along a predetermined route. Gathering this type of information may be problematic. For example, relying on a driver of a vehicle to enter information about a traffic condition, or the like, could place the driver at risk. The act of entering data (e.g., texting) while driving is inherently unsafe. Further, drivers may not be relied upon to consistently enter data.

### SUMMARY

The following presents a simplified summary that describes some aspects or embodiments of the subject disclosure. This summary is not an extensive overview of the disclosure. Indeed, additional or alternative embodiments of the subject disclosure may be available beyond those described in the summary.

Sensors on vehicles may be used to automatically obtain data about events and/or conditions pertaining to vehicles. Obtaining the data may be transparent to a driver of a vehicle. The data may be obtained without driver intervention. Vehicle sensor data may be received from multiple vehicles and aggregated to determine an event. An indication of the event may be provided to, for example, a server, third party, agency, subscriber, a vehicle, a driver, or the like. In example embodiments, data may be obtained regarding a vehicle pertaining to, for example, location, braking, acceleration, turning, stopping, speed, direction, video data (e.g., via a camera on the vehicle), tire pressure, depth, altitude, or the like, or any appropriate combination thereof. The obtained data may be utilized to determine if events related to a vehicle and/or events related to a proximate area are occurring and to determine a condition associated with the event. For example, data indicating the brake and accelerator pedal are being depressed frequently may indicate a congested traffic condition. This may be correlated with a current location of the vehicle to determine a location of a traffic jam. A sharp turn of a steering wheel and sudden deceleration may indicate that a vehicle has been in an accident or has nearly been in an accident. And this may be correlated with a location of the vehicle to indicate where the accident has occurred. This information may be provided to a server, third party, agency, of the like, for subsequent analysis and/or in order to obtain aid. A rapid, transient change in tire pressure may indicate a pothole or the like in a road. This information may be correlated with a location of the vehicle to provide an indication of the location of the pothole. As another example, depth reading from a depth finder of a marine vehicle may be obtained and provided in order to update channel charts. Information may be provided via a mobile communications device, a device integrated with the vehicle, or any appropriate combination thereof.

### BRIEF DESCRIPTION OF THE DRAWINGS

Reference is made here to the accompanying drawings, which are not necessarily drawn to scale.

FIG. 1 is a flow diagram of an example process for event and condition determination based on sensor data.

FIG. 2 is a diagram of an example system and process for event and condition determination based on sensor data.

FIG. 3 is a block diagram of an example communications device that may be utilized for event and condition determination based on sensor data.

FIG. 4 is a block diagram of an example vehicular entity that may be utilized for event and condition determination based on sensor data.

FIG. 5 is a block diagram of an example network entity that may be utilized for event and condition determination based on sensor data.

FIG. 6 is a diagram of an example communications system in which event and condition determination based on sensor data may be implemented.

FIG. 7 is a system diagram of an example wireless transmit/receive unit.

FIG. 8 is an example system diagram of radio access network and core network.

FIG. 9 depicts an overall block diagram of an example packet-based mobile cellular network environment, such as a GPRS network, within which event and condition determination based on sensor data may be implemented.

FIG. 10 illustrates an architecture of a typical GPRS network within which event and condition determination based on sensor data may be implemented.

FIG. 11 illustrates an example block diagram view of a GSM/GPRS/IP multimedia network architecture within which event and condition determination based on sensor data may be implemented.

FIG. 12 illustrates a PLMN block diagram view of an example architecture in which event and condition determination based on sensor data may be incorporated.

### DETAILED DESCRIPTION OF ILLUSTRATIVE EMBODIMENTS

Aspects of the instant disclosure are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout.

Communications device (e.g., smart phones, PDA, tablets, laptops, computers, etc.) and vehicles (e.g., cars, trucks, planes, boats, individuals, etc.) may be equipped with an array of sensors, such as, for example, accelerometers, dead reckoning, gyroscopes, yaw sensors, pitch sensors, pressure sensors (e.g., pedal pressure sensors, air pressure sensors, fluid pressure sensors, etc.), steering wheel angle sensors, GPS units, speedometers, or the like. Data obtained from these sensors may be made available to entities such as, for example, third party software services. Data obtained from these sensors may be provided from, for example, the communication device, a vehicular entity such as a processor integrated with the vehicle, vehicle's embedded Telematics Control Unit (TCU), or the like, or any appropriate combination thereof.

As described herein, a vehicle's controller area network (CAN) may be utilized to capture and provide (via the TCU) batch data to an off board software service to analyze and determine specific road segment location incidents that may require cautious maneuverability. The CAN may be designed as a subsystem used to control actuators and receive feedback from electronic control units (ECU) and sensors that may be located throughout the vehicle. The data that is captured may be geotagged and used to help improve driver behavior and overall driver experience. For example, sensor data that is captured when several drivers must brake or accelerate hard to merge onto an expressway or to avoid an accident due to icy conditions may be processed and analyzed to pinpoint and warn other drivers that difficult road segments may be coming up on their route.

As another example, sensors may recognize that a vehicle is currently moving in stop-and-go traffic on a highway during certain points of the day. Such events may be geotagged and uploaded to a server, or the like, via wireless networking technology. The server may perform analysis on data streams from multiple participating vehicles based on the time of day for example. This aggregated data analysis may allow the server to determine global events such as, for example, a stretch of road that is particularly dangerous, a road location under construction, a traffic jam, or the like, or any appropriate combination thereof. Such information may be of interest to drivers of vehicles, fleet managers, institutions (e.g., city road department, municipalities), businesses that sell goods and services in the automotive market, or the like.

Information may be presented to drivers on a variety of devices and in various ways designed to rapidly alert a driver while attempting to minimize driver cognitive and/or visual distraction. For example, data may be conveyed to a driver's mobile communications device which would vibrate, as an auditory signal mixed into the music the driver is listening to, as visual information displayed on a navigation or driver information center (DIC) display screen built into the vehicle's headunit or heads-up display. Information also may be haptically provided through driver touch points such as the steering wheel or seat via vibration sensors. Information, such as an indication of an event may be provided audibly via an acoustic transmitter (e.g., speaker, buzzer, etc.) of the vehicle.

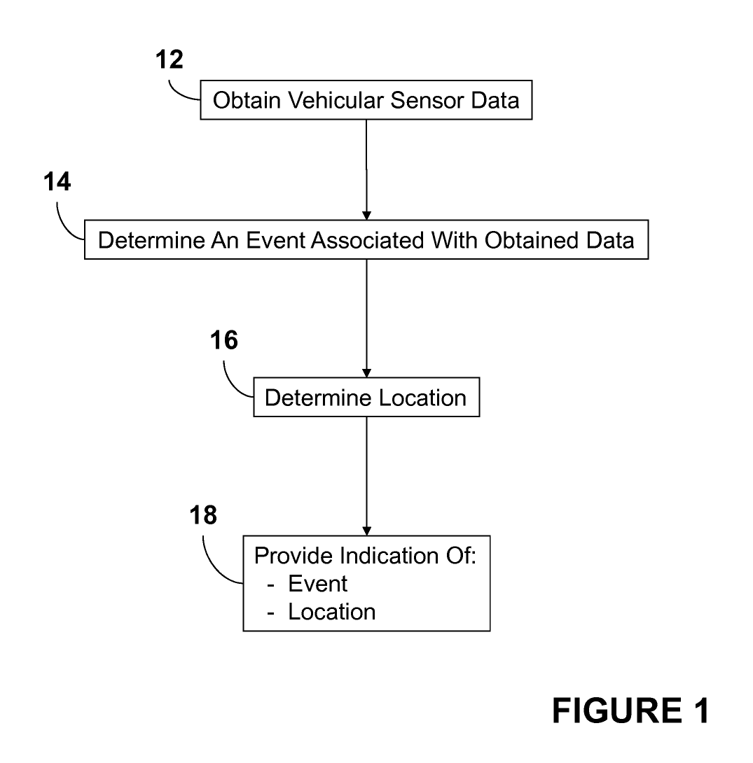

FIG. 1 is a flow diagram of an example process for event and condition determination based on sensor data. Vehicular sensor data may be obtained at step 12. Vehicle sensor data may include any appropriate data relating to a vehicle, such as, for example, location, braking, acceleration, turning, stopping, speed, direction, video data (e.g., via a camera on the vehicle), tire pressure, air pressure, fluid pressure, depth, altitude, tread depth, or the like, or any appropriate combination thereof. In an example embodiment, vehicular sensor data comprises an indication of a vehicular maneuver, such as, for example, swerving, stopping, decelerating, accelerating, or the like, or any appropriate combination thereof. Vehicle sensor data also may comprise information that allows the detection of events external to the vehicle. For example, vehicular cameras may capture video information that may be analyzed to detect events of interest in the immediate environment such as unsafe behavior on the part of other vehicles. Using temperature and atmospheric sensors, dangerous road conditions such as black ice may be predicted. Emissions and other engine systems sensor data may be analyzed to predict imminent failure of vehicular systems such as, for example, the propulsion system (engine and transmission), suspension, or braking subsystems.

Vehicular sensor data may be obtained via any appropriate sensor, such as, for example, a pressure sensor (e.g., a tire pressure sensor, a master cylinder fluid pressure sensor, a atmospheric pressure sensor), a temperature sensor, an accelerometer, a brake pressure sensor, a steering wheel angle sensor, a yaw sensor, occupancy sensors (e.g. pressure sensors in the seats), a velocity sensor, a directional bearing sensor, emissions sensors, a location sensor (e.g., Global Positioning System, GPS sensor), a shock absorber sensor, a moisture sensor, a gyroscope, a pedal position sensor (e.g., brake, accelerator, clutch, etc.), a throttle position sensor, a camera (.e.g., rear, side, front, interior, exterior, etc.), or the like, or any appropriate combination thereof.

A vehicle may comprise any appropriate vehicle, such as, for example, a land vehicle (e.g., car, truck, motorcycle, bicycle, all-terrain vehicle, buggy, quad runner, etc.), an air vehicle (e.g., airplane, jet, propeller plane, helicopter, dirigible, balloon, etc.), a marine vehicle (ship, submarine, barge, float, buoy, etc.), an individual, or the like, or any appropriate combination thereof.

An event associated with the obtained data may be determined at step 14. An event may comprise any appropriate event, such as, for example, an indication of congested traffic, a disruption in a road surface (e.g., pothole, crack, etc.), an indication of an accident, an indication of an obstruction in the road (e.g., disabled vehicle, trash, etc.), hazardous weather conditions, an indication of unsafe behavior on the part of another vehicle, pedestrians, or animals, an indication of impending failure of one of a vehicle's subsystems or of some other vehicle's subsystems, a missing traffic sign, a poorly lit sign, a sign having an obstructed view, a detour, or the like, or any appropriate combination thereof.

Events may be associated with vehicular data in any appropriate manner. For example, data indicating the brake and accelerator pedal are being depressed frequently may indicate a congested traffic condition. A sharp turn of a steering wheel and sudden deceleration may indicate that a vehicle has been in an accident or almost was in an accident, that an obstruction is in the road, or the like. Activation of an antilock braking system and temperature data may indicate hazardous weather conditions (e.g., slippery road surface, icy road surface, wet road surface, etc.). In an example embodiment, information from multiple vehicles may be aggregated to associate and/or reinforce an association of an event with vehicular sensor data. The aggregated data may be analyzed to determine if an event exists and/or the nature of an event. The aggregated data may be utilized to gain a clearer understanding of an event, such as, for example, a dangerous road condition, traffic conditions, impending vehicle subsystem failure, etc.

A location of the vehicle may be determined at step 16. Location may be determined in any appropriate manner via any appropriate type of location determination system including, for example, the Global Positioning System (GPS), assisted GPS (A-GPS), time difference of arrival calculations, configured constant location (in the case of non-moving devices), dead reckoning (e.g., based on, for example, velocity, steering wheel angle, yaw sensor data, accelerometer data, etc.), any combination thereof, or any other appropriate means. In an example embodiment, a location of a mobile communications device and/or built-in cellular receiver within and/or near a vehicle may be determined and a location of the vehicle may be inferred from the location of the mobile communications device and/or built-in cellular receiver. For example, a location of a smart phone or built-in cellular receiver located within a vehicle may be used to infer that the location of the vehicle is the same as the location of the smart phone or built-in cellular receiver.

An indication of the event and the location may be provided at step 18. Information may be provided to any appropriate entity, such as, for example, a server, third party, agency, subscriber, an off-board (with respect to the vehicle) service, a network entity, drivers of other vehicles, fleet managers, institutions (e.g., city road department, municipalities), businesses that sell goods and services in the automotive market, or the like, or any appropriate combination thereof. In an example embodiment, vehicular sensor data may be sent to a network entity or the like, the network entity may determine an event associated with the vehicular sensor data, and provide an indication the event, at step 18, to equipment on and/or in the vehicle.

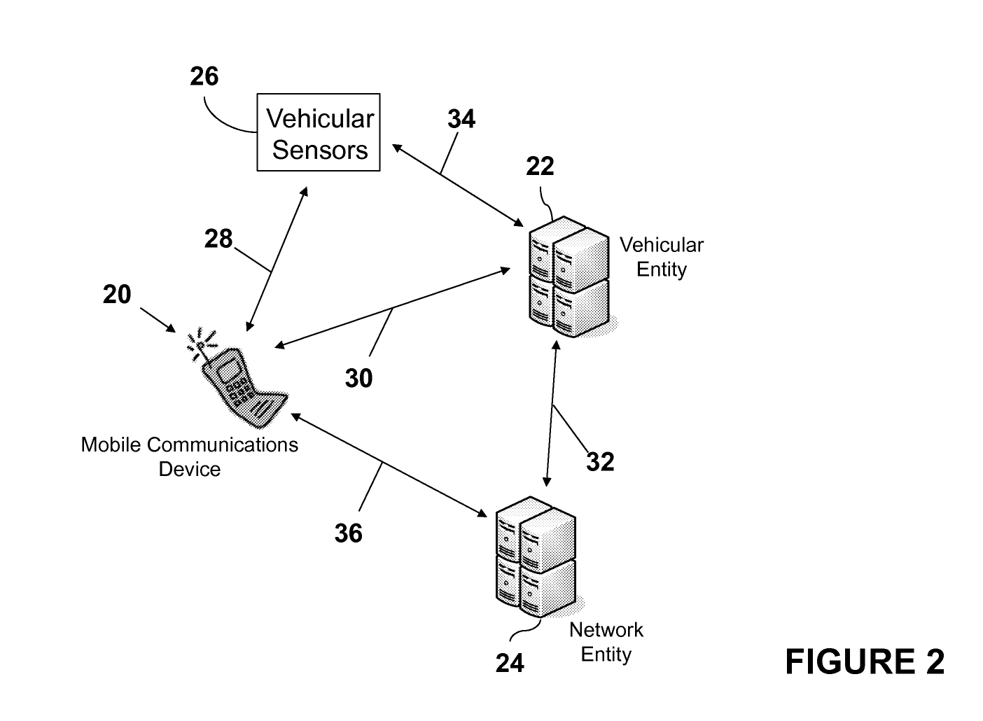

FIG. 2 is a diagram of an example system and process for event and condition determination based on sensor data. The system depicted in FIG. 2 may be utilized to perform the processes depicted in FIG. 1. In an example embodiment, the system depicted in FIG. 2 may comprise vehicular sensors 26, a mobile communications device 20, a vehicular entity 22, a network entity 24, or any appropriate combination thereof.

Vehicular sensors 26 may comprise any appropriate vehicular sensors as described herein. For example vehicular sensors 26 may comprise any appropriate combination of a pressure sensor, a temperature sensor, an accelerator, an accelerometer, a brake pressure sensor, a steering wheel angle sensor, a speedometer, a location sensor (e.g., Global Positioning System, GPS sensor), a shock absorber sensor, a moisture sensor, a gyroscope, a pedal position sensor (e.g., brake, gas, etc.), a throttle position sensor, a camera (.e.g., rear, side, front, interior, exterior, etc.), or the like.

Vehicular sensors 26 may communicate with the mobile communications device 20 (indicate by arrow 28), the vehicular sensors 26 may communicate with the vehicular entity 22 (indicated by arrow 34) or any appropriate combination thereof. Communications may comprise requesting sensor data and/or providing sensor data. As described in more detail herein, the mobile communications device may comprise any appropriate communications device such as, for example, a smart phone, PDA, laptop, tablet, a vehicle embedded cellular transceiver, or the like. The vehicular entity 22 may comprise any appropriate vehicular entity, such as, for example, a computer, a processor, a server, a Telematics Control Unit (TCU), or the like, or any appropriate combination thereof.

The mobile communications device 20 may communicate with the vehicular entity 22 (depicted by arrow 30), the mobile communications device 20 may communicate with the network entity 24 (depicted by arrow 36), or any appropriate combination thereof. The vehicular entity 22 may communicate with the network entity 24 (depicted by arrow 32).

As described in more detail herein, the network entity 24 may comprise any appropriate network entity. For example, the network entity 24 may comprise a server, gateway, node, processor, or the like of a communications network (e.g., wireless communications network). The network entity 24 may comprise equipment of a third party such as, for example a government agency, a municipality, a retailer, an off-board (with respect to the vehicle) service, of other vehicles, fleet managers, institutions (e.g., city road department), businesses that sell goods and services in the automotive market, or the like.

The processes depicted in FIG. 1 may be accomplished via the system depicted in FIG. 2 in various ways. For example, sensor data from vehicular sensors 26 may be provided directly to the mobile communications device 20 via wireless communications mechanisms (e.g., WiFi, Bluetooth, near field communications, the control area network—CAN, etc.). The mobile communications device 20 may determine locations, determine events associated sensor data and provide results. The mobile communications device 20 may provide results to the vehicular entity 22, the network entity 24, or any appropriate combination thereof.

In another example embodiment, sensor data from vehicular sensors 26 may be provided directly to the vehicular entity 22. The sensor data may be provided wirelessly (e.g., WiFi, Bluetooth, near field communications, etc.), via a CAN bus, or any appropriate combination thereof. The vehicular entity 22 may determine locations, determine events associated sensor data and provide results. The vehicular entity 22 may provide results to the mobile communications device 20, the network entity 24, or any appropriate combination thereof.

In another example embodiment, sensor data from vehicular sensors 26 may be provided to the network entity 24 via mobile communications device 20, the vehicular entity 22, or any appropriate combination thereof. The network entity 24 may determine locations, determine events associated sensor data and provide results. The network entity 24 may provide results to the mobile communications device 20, the vehicular entity 24, or any appropriate combination thereof.

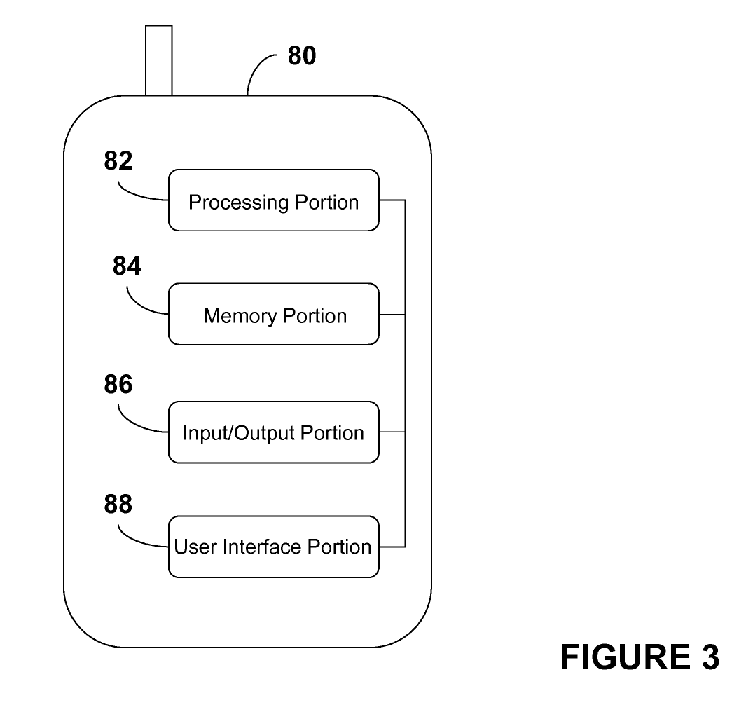

FIG. 3 is a block diagram of an example communications device 80 that may be utilized for event and condition determination based on sensor data. In an example embodiment, the communications device 80 may comprise the mobile communications device 20 depicted in FIG. 2. In an example configuration, communications device 80 comprises a mobile wireless device. The communications device 80, however, may comprise any appropriate device, examples of which include a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a Walkman, etc.), a portable navigation device (e.g., GPS compatible device, A-GPS compatible device, etc.), or a combination thereof. The communications device 80 may include devices that are not typically thought of as portable, such as, for example, a public computing device, a navigation device installed in-vehicle, a set top box, or the like. The mobile communications device 80 can include non-conventional computing devices, such as, for example, a kitchen appliance, a motor vehicle control (e.g., steering wheel), etc., or the like. As evident from the herein description a communications device, a mobile device, or any portion thereof is not to be construed as software per se.

The communications device 80 may include any appropriate device, mechanism, software, and/or hardware for event and condition determination based on sensor data as described herein. In an example embodiment, event and condition determination based on sensor data is a feature of the communications device 80 that can be turned on and off Thus, in an example embodiment, an owner of the communications device 80 may opt-in or opt-out of this capability.

In an example embodiment, the communications device 80 may comprise a processor and memory coupled to the processor. The memory may comprise executable instructions that when executed by the processor cause the processor to effectuate operations associated with event and condition determination based on sensor data.

In an example configuration, the communications device 80 may comprise a processing portion 82, a memory portion 84, an input/output portion 86, and a user interface (UI) portion 88. Each portion of the communications device 80 may comprise circuitry for performing functions associated with event and condition determination based on sensor data. Thus, each portion may comprise hardware, or a combination of hardware and software. Accordingly, each portion of the communications device 80 is not to be construed as software per se. It is emphasized that the block diagram depiction of communications device 80 is exemplary and not intended to imply a specific implementation and/or configuration. For example, in an example configuration, the communications device 80 may comprise a cellular phone and the processing portion 82 and/or the memory portion 84 may be implemented, in part or in total, on a subscriber identity module (SIM) of the mobile communications device 80. In another example configuration, the communications device 80 may comprise a laptop computer, tablet, or the like, which may include a SIM, and various portions of the processing portion 82 and/or the memory portion 84 can be implemented on the SIM, on the laptop other than the SIM, a vehicle embedded cellular transceiver, or any combination thereof.

The processing portion 82, memory portion 84, and input/output portion 86 may be coupled together to allow communications therebetween. In various embodiments, the input/output portion 86 may comprise a receiver of the communications device 80, a transmitter of the communications device 80, or a combination thereof. The input/output portion 86 may be capable of receiving and/or providing information pertaining to event and condition determination based on sensor data as described herein. In various configurations, the input/output portion 86 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof.

The processing portion 82 may be capable of performing functions pertaining to event and condition determination based on sensor data as described herein. In a basic configuration, the communications device 80 may include at least one memory portion 84. The memory portion 84 may comprise a storage medium having a tangible physical structure. Thus, the memory portion 84, as well as any computer-readable storage medium described herein, is not to be construed as a transient signal per se. Further, the memory portion 84, as well as any computer-readable storage medium described herein, is not to be construed as a propagating signal per se. The memory portion 84 may store any information utilized in conjunction with event and condition determination based on sensor data as described herein. Depending upon the exact configuration and type of processor, the memory portion 84 may be volatile (such as some types of RAM), non-volatile (such as ROM, flash memory, etc.), or a combination thereof. The mobile communications device 80 may include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile communications device 80.

The communications device 80 also may contain a user interface (UI) portion 88 allowing a user to communicate with the communications device 80. The UI portion 88 may be capable of rendering any information utilized in conjunction with event and condition determination based on sensor data as described herein. The UI portion 88 may provide the ability to control the communications device 80, via, for example, buttons, soft keys, voice actuated controls, a touch screen, movement of the mobile communications device 80, visual cues (e.g., moving a hand in front of a camera on the mobile communications device 80), or the like. The UI portion 88 may provide visual information (e.g., via a display), audio information (e.g., via speaker), mechanically (e.g., via a vibrating mechanism), or a combination thereof. In various configurations, the UI portion 88 may comprise a display, a touch screen, a keyboard, an accelerometer, a motion detector, a speaker, a microphone, a camera, a tilt sensor, or any combination thereof. The UI portion 88 may comprise means for inputting biometric information, such as, for example, fingerprint information, retinal information, voice information, and/or facial characteristic information.

The UI portion 88 may include a display for displaying multimedia such as, for example, application graphical user interfaces (GUIs), text, images, video, telephony functions such as Caller ID data, setup functions, menus, music, metadata, messages, wallpaper, graphics, Internet content, device status, preferences settings, map and location data, routes and other directions, points of interest (POI), and the like.

In some embodiments, the UI portion may comprise a user interface (UI) application. The UI application may interface with a client or operating system (OS) to, for example, facilitate user interaction with device functionality and data. The UI application may aid a user in entering message content, viewing received messages, answering/initiating calls, entering/deleting data, entering and setting user IDs and passwords, configuring settings, manipulating content and/or settings, interacting with other applications, or the like, and may aid the user inputting selections associated with event and condition determination based on sensor data as described herein. The UI portion may aid in rendering messages (e.g., visually, audibly, mechanically, etc.) resulting from event and condition determination based on sensor data as described herein.

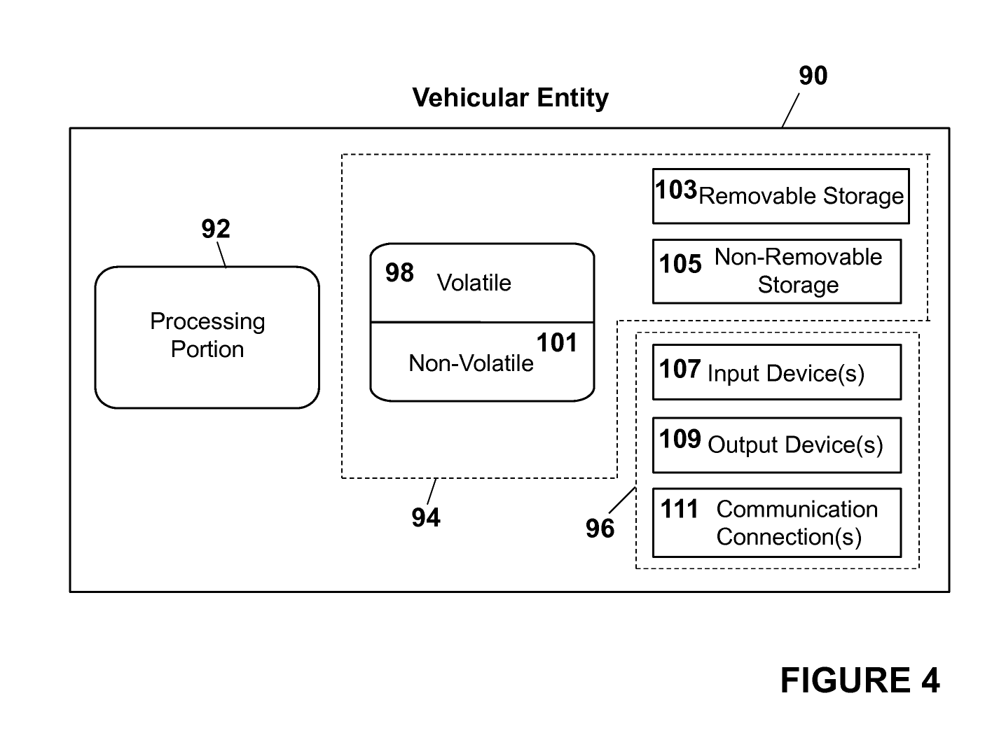

FIG. 4 is a block diagram of an example vehicular entity 90 that may be utilized for event and condition determination based on sensor data. The vehicular entity 90 may comprise hardware or a combination of hardware and software. When used in conjunction with a network, the functionality needed to facilitate management of event and condition determination based on sensor data may reside in any one or combination of network entities. The vehicular entity 90 depicted in FIG. 4 represents any appropriate network entity, or combination of network entities, such as, for example, a processor, a server, a gateway, a node, the vehicular entity 22 depicted in FIG. 2. In an example embodiment, the vehicular entity 90 comprises the aforementioned telematics control unit (TCU). In an example configuration, the vehicular entity 90 may comprise a component or various components of a cellular broadcast system wireless network. It is emphasized that the block diagram depicted in FIG. 4 is exemplary and not intended to imply a specific implementation or configuration. Thus, the vehicular entity 90 may be implemented in a single processor or multiple processors (e.g., single server or multiple servers, single gateway or multiple gateways, etc.). Multiple conversion servers may be distributed or centrally located. Multiple conversion servers may communicate wirelessly, via hard wire, or a combination thereof.

In an example embodiment, the vehicular entity 90 may comprise a processor and memory coupled to the processor. The memory may comprise executable instructions that when executed by the processor cause the processor to effectuate operations associated with event and condition determination based on sensor data. As evident from the herein description a network entity or any portion thereof is not to be construed as software per se.

In an example configuration, the vehicular entity 90 may comprise a processing portion 92, a memory portion 94, and an input/output portion 96. The processing portion 92, memory portion 94, and input/output portion 96 may be coupled together (coupling not shown in FIG. 4) to allow communications therebetween. The input/output portion 96 may be capable of receiving and/or providing information from/to a communications device and/or other conversion servers configured to be utilized with event and condition determination based on sensor data. For example, the input/output portion 96 may include a wireless communications (e.g., 2.5G/3G/4G/GPS) card. The input/output portion 96 may be capable of receiving and/or sending video information, audio information, control information, image information, data, or any combination thereof. In an example embodiment, the input/output portion 36 may be capable of receiving and/or sending information to determine a location of the vehicular entity 90, the communications device 80, and/or the mobile communications device 20. In an example configuration, the input\output portion 96 may comprise a GPS receiver. In an example configuration, the vehicular entity 90 may determine its own geographical location and/or the geographical location of a communications device through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 96 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion may comprise a WIFI finder, a two way GPS chipset or equivalent, or the like, or a combination thereof.

The processing portion 92 may be capable of performing functions associated with event and condition determination based on sensor data as described herein. That is, a communications device (e.g., intended recipient(s) 32, communications device 80, etc.) may perform functions internally (by the device) and/or utilize the vehicular entity 90 to perform functions. For example, the processing portion 92 may be capable of, in conjunction with any other portion of the vehicular entity 90, installing an application for event and condition determination based on sensor data. The processing portion 92, in conjunction with any other portion of the vehicular entity 90, may enable the vehicular entity 90 to covert speech to text when it is configured to also send text messages.

In a basic configuration, the vehicular entity 90 may include at least one memory portion 94. The memory portion 94 may comprise a storage medium having a tangible physical structure. Thus, the memory portion 94, as well as any computer-readable storage medium described herein, is not to be construed as a transient signal per se. The memory portion 94, as well as any computer-readable storage medium described herein, is not to be construed as a propagating signal per se. The memory portion 94 may store any information utilized in conjunction with event and condition determination based on sensor data as described herein. Depending upon the exact configuration and type of processor, the memory portion 94 may be volatile 98 (such as some types of RAM), non-volatile 101 (such as ROM, flash memory, etc.), or a combination thereof. The vehicular entity 90 may include additional storage (e.g., removable storage 103 and/or non-removable storage 105) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the vehicular entity 90.

The vehicular entity 90 also may contain communications connection(s) 111 that allow the vehicular entity 90 to communicate with other devices, network entities, or the like. A communications connection(s) may comprise communication media. Communication media may embody computer readable instructions, data structures, program modules or other data in a modulated data signal such as a carrier wave or other transport mechanism and includes any information delivery media. By way of example, and not limitation, communication media may include wired media such as a wired network or direct-wired connection, and wireless media such as acoustic, RF, infrared, and other wireless media. The term computer readable media as used herein includes both storage media and communication media. The vehicular entity 90 also may include input device(s) 107 such as keyboard, mouse, pen, voice input device, touch input device, etc. Output device(s) 109 such as a display, speakers, printer, etc. also may be included.

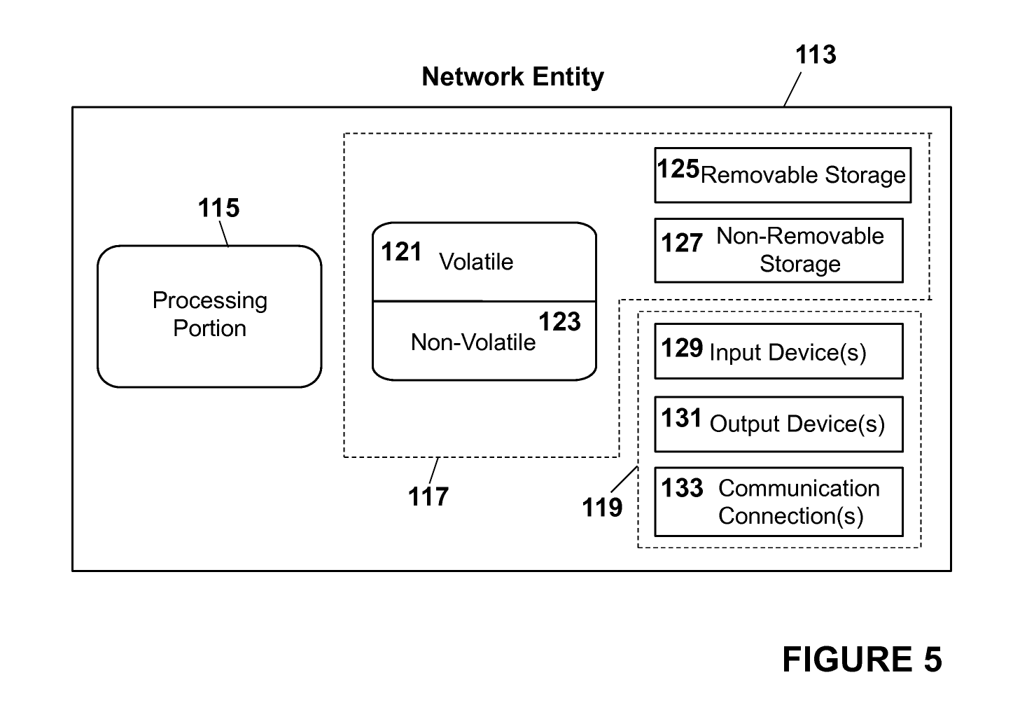

FIG. 5 is a block diagram of an example network entity 113 that may be utilized for event and condition determination based on sensor data. The network entity 113 may comprise hardware or a combination of hardware and software. When used in conjunction with a network, the functionality needed to facilitate management of event and condition determination based on sensor data may reside in any one or combination of network entities. The network entity 113 depicted in FIG. 5 represents any appropriate network entity, or combination of network entities, such as, for example, a processor, a server, a gateway, a node, the network entity 24 depicted in FIG. 2. In an example configuration, the network entity 113 may comprise a component or various components of a cellular broadcast system wireless network. It is emphasized that the block diagram depicted in FIG. 5 is exemplary and not intended to imply a specific implementation or configuration. Thus, the network entity 113 may be implemented in a single processor or multiple processors (e.g., single server or multiple servers, single gateway or multiple gateways, etc.). Multiple conversion servers may be distributed or centrally located. Multiple conversion servers may communicate wirelessly, via hard wire, or a combination thereof.

In an example embodiment, the network entity 113 may comprise a processor and memory coupled to the processor. The memory may comprise executable instructions that when executed by the processor cause the processor to effectuate operations associated with event and condition determination based on sensor data. As evident from the herein description a network entity or any portion thereof is not to be construed as software per se.

In an example configuration, the network entity 113 may comprise a processing portion 115, a memory portion 117, and an input/output portion 119. The processing portion 115, memory portion 117, and input/output portion 119 may be coupled together (coupling not shown in FIG. 5) to allow communications therebetween. The input/output portion 119 may be capable of receiving and/or providing information from/to a communications device and/or other conversion servers configured to be utilized with event and condition determination based on sensor data. For example, the input/output portion 119 may include a wireless communications (e.g., 2.5G/3G/4G/GPS) card. The input/output portion 119 may be capable of receiving and/or sending video information, audio information, control information, image information, data, or any combination thereof. In an example embodiment, the input/output portion 36 may be capable of receiving and/or sending information to determine a location of the network entity 113, the communications device 80, and/or the mobile communications device 20. In an example configuration, the input\output portion 119 may comprise a GPS receiver. In an example configuration, the network entity 113 may determine its own geographical location and/or the geographical location of a communications device through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 119 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion may comprise a WIFI finder, a two way GPS chipset or equivalent, or the like, or a combination thereof.

The processing portion 115 may be capable of performing functions associated with event and condition determination based on sensor data as described herein. That is, a communications device (e.g., intended recipient(s) 32, communications device 80, etc.) may perform functions internally (by the device) and/or utilize the network entity 113 to perform functions. For example, the processing portion 115 may be capable of, in conjunction with any other portion of the network entity 113, installing an application for event and condition determination based on sensor data. The processing portion 115, in conjunction with any other portion of the network entity 113, may enable the network entity 113 to covert speech to text when it is configured to also send text messages.

In a basic configuration, the network entity 113 may include at least one memory portion 117. The memory portion 117 may comprise a storage medium having a tangible physical structure. Thus, the memory portion 117, as well as any computer-readable storage medium described herein, is not to be construed as a transient signal per se. The memory portion 117, as well as any computer-readable storage medium described herein, is not to be construed as a propagating signal per se. The memory portion 117 may store any information utilized in conjunction with event and condition determination based on sensor data as described herein. Depending upon the exact configuration and type of processor, the memory portion 117 may be volatile 121 (such as some types of RAM), non-volatile 123 (such as ROM, flash memory, etc.), or a combination thereof. The network entity 113 may include additional storage (e.g., removable storage 125 and/or non-removable storage 127) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the network entity 113.

The network entity 113 also may contain communications connection(s) 133 that allow the network entity 113 to communicate with other devices, network entities, or the like. A communications connection(s) may comprise communication media. Communication media may embody computer readable instructions, data structures, program modules or other data in a modulated data signal such as a carrier wave or other transport mechanism and includes any information delivery media. By way of example, and not limitation, communication media may include wired media such as a wired network or direct-wired connection, and wireless media such as acoustic, RF, infrared, and other wireless media. The term computer readable media as used herein includes both storage media and communication media. The network entity 113 also may include input device(s) 129 such as keyboard, mouse, pen, voice input device, touch input device, etc. Output device(s) 131 such as a display, speakers, printer, etc. also may be included.

A communications device and/or conversion server may be part of and/or in communications with various wireless communications networks. Some of which are described below.

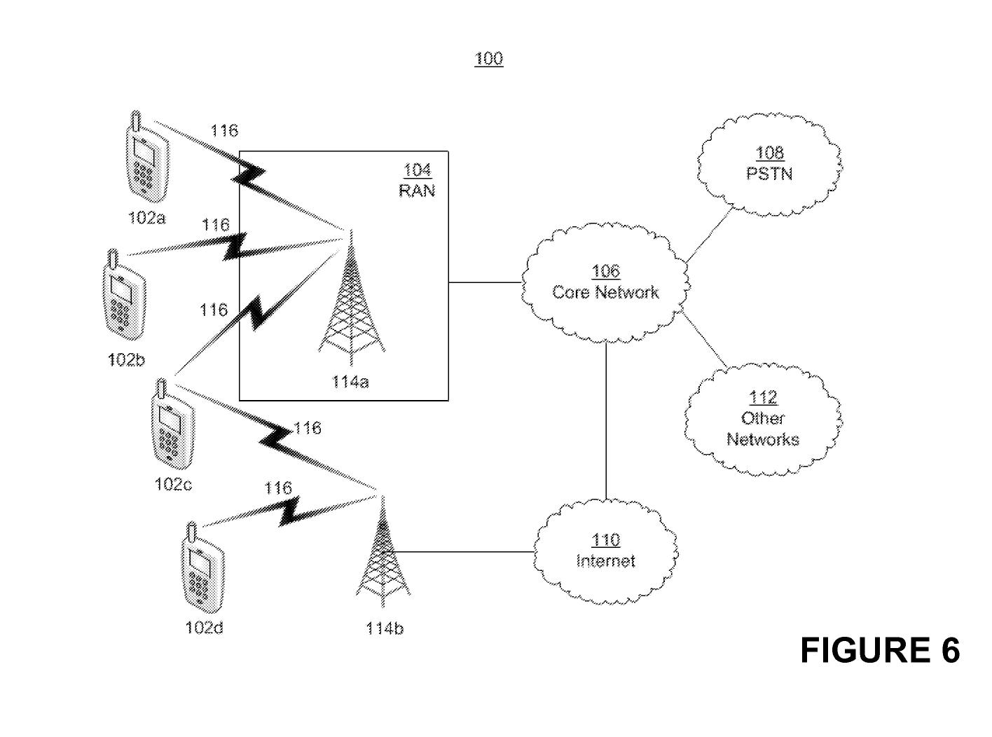

FIG. 6 is a diagram of an example communications system in which event and condition determination based on sensor data may be implemented. The communications system 100 may comprise a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. A communications system such as that shown in FIG. 6 may also be referred to herein as a network.

As shown in FIG. 6, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. For example, a WTRU may comprise intended recipient(s) 32, communications device 80, or the like, or any combination thereof. By way of example, the WTRUs 102a, 102b, 102c, 102d may be configured to transmit and/or receive wireless signals and may include user equipment (UE), a mobile station, a mobile device, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA) that may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 6 may comprise a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 6, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 6, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 6 may be configured to communicate with the base station 114a, which may employ a cellular-based radio technology, and with the base station 114b, which may employ an IEEE 802 radio technology.

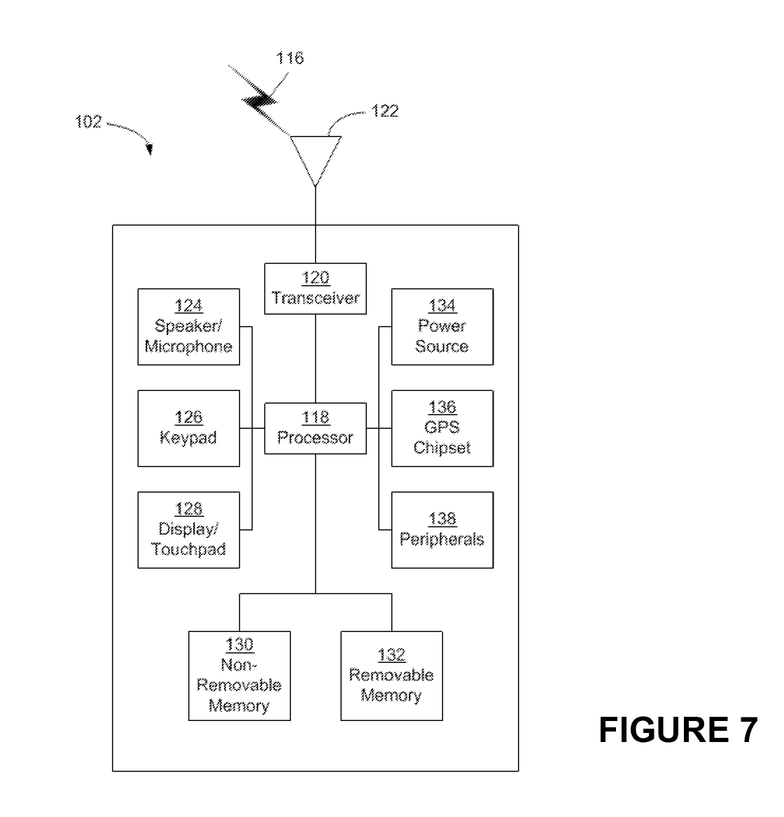

FIG. 7 is a system diagram of an example WTRU 102. As shown in FIG. 7, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 7 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 7 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

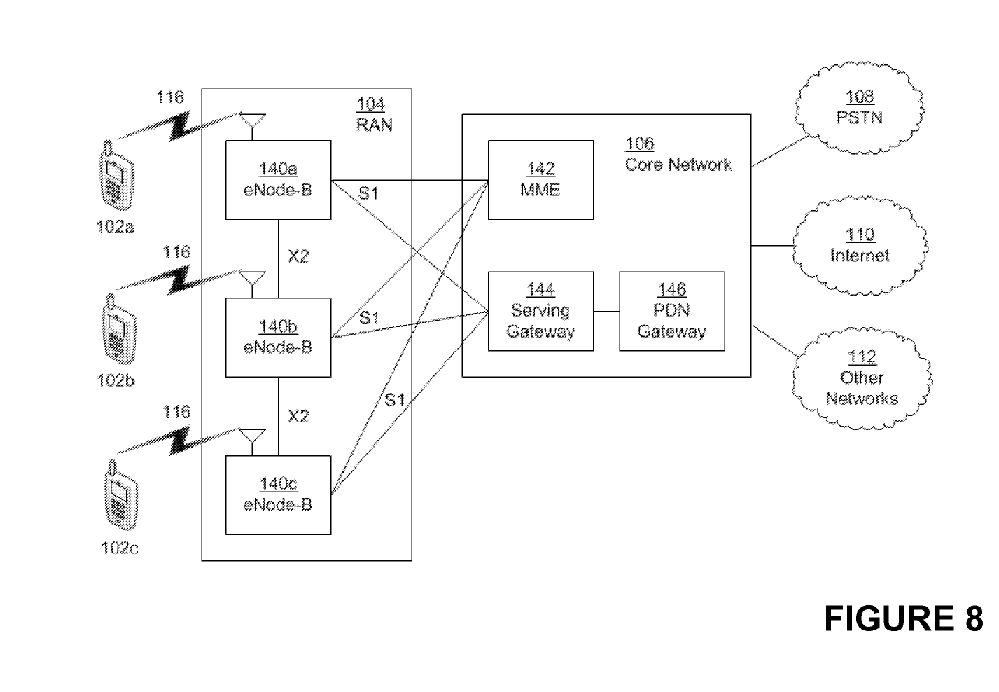

FIG. 8 is an example system diagram of RAN 104 and core network 106. As noted above, the RAN 104 may employ an E-UTRA radio technology to communicate with the WTRUs 102a, 102b, and 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, and 140c may be associated with a particular cell (not shown) and may be configured to handle radio resource management decisions, handover decisions, scheduling of users in the uplink and/or downlink, and the like. As shown in FIG. 8, the eNode-Bs 140a, 140b, 140c may communicate with one another over an X2 interface.

The core network 106 shown in FIG. 8 may include a mobility management gateway or entity (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode-Bs 140a, 140b, and 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

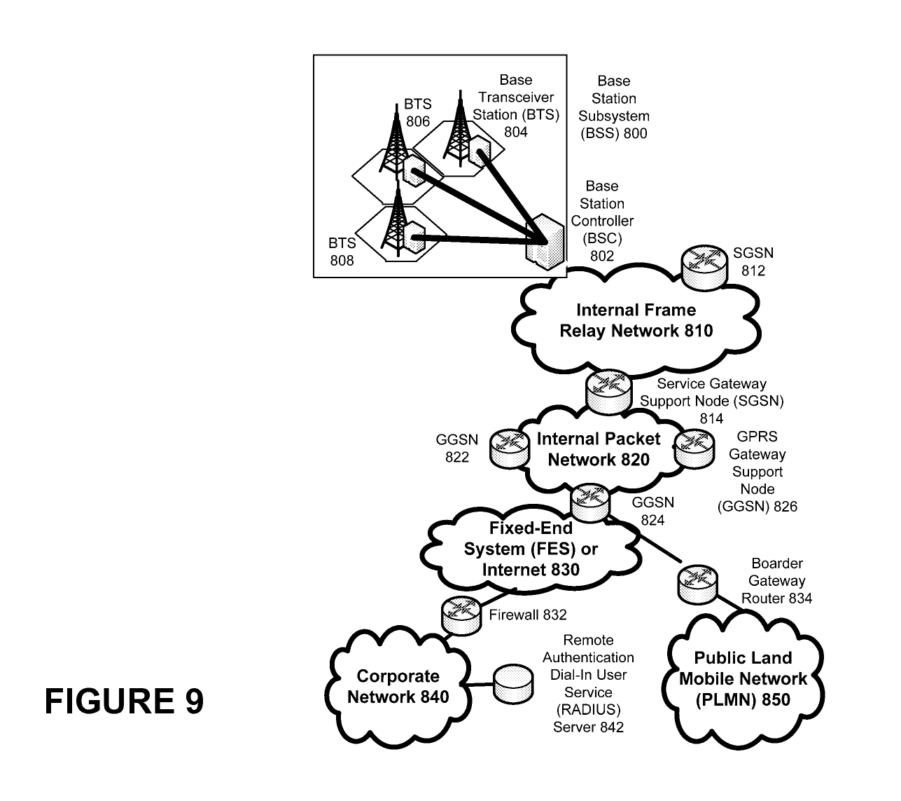

FIG. 9 depicts an overall block diagram of an example packet-based mobile cellular network environment, such as a GPRS network, within which event and condition determination based on sensor data may be implemented. In the example packet-based mobile cellular network environment shown in FIG. 9, there are a plurality of Base Station Subsystems (“BSS”) 800 (only one is shown), each of which comprises a Base Station Controller (“BSC”) 802 serving a plurality of Base Transceiver Stations (“BTS”) such as BTSs 804, 806, and 808. BTSs 804, 806, 808, etc. are the access points where users of packet-based mobile devices become connected to the wireless network. In example fashion, the packet traffic originating from user devices is transported via an over-the-air interface to a BTS 808, and from the BTS 808 to the BSC 802. Base station subsystems, such as BSS 800, are a part of internal frame relay network 810 that can include Service GPRS Support Nodes (“SGSN”) such as SGSN 812 and 814. Each SGSN is connected to an internal packet network 820 through which a SGSN 812, 814, etc. can route data packets to and from a plurality of gateway GPRS support nodes (GGSN) 822, 824, 826, etc. As illustrated, SGSN 814 and GGSNs 822, 824, and 826 are part of internal packet network 820. Gateway GPRS serving nodes 822, 824 and 826 mainly provide an interface to external Internet Protocol (“IP”) networks such as Public Land Mobile Network (“PLMN”) 850, corporate intranets 840, or Fixed-End System (“FES”) or the public Internet 830. As illustrated, subscriber corporate network 840 may be connected to GGSN 824 via firewall 832; and PLMN 850 is connected to GGSN 824 via boarder gateway router 834. The Remote Authentication Dial-In User Service (“RADIUS”) server 842 may be used for caller authentication when a user of a mobile cellular device calls corporate network 840.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

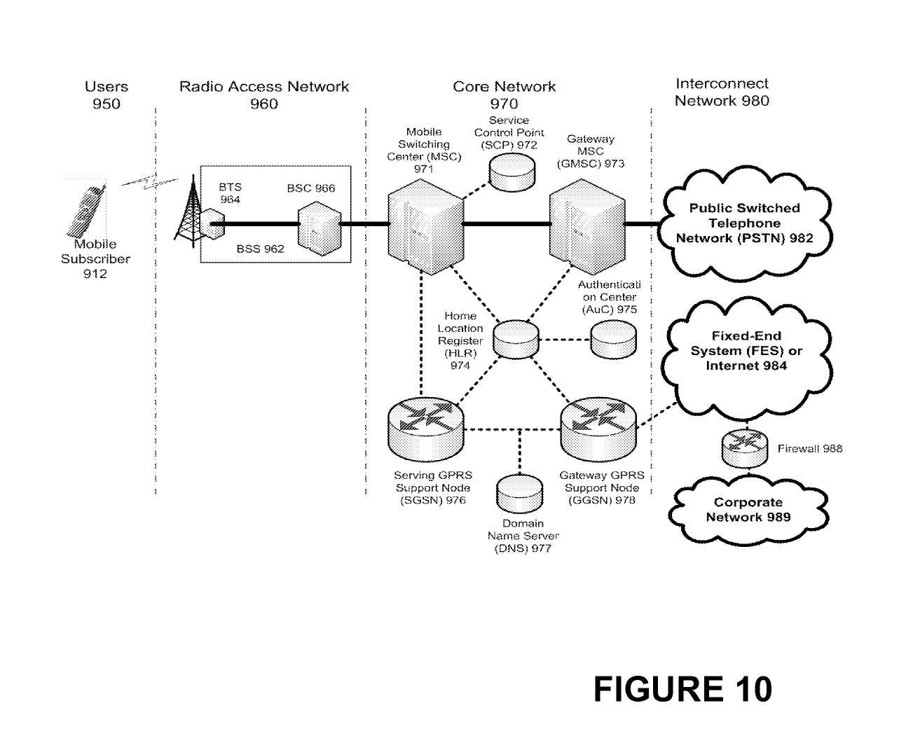

FIG. 10 illustrates an architecture of a typical GPRS network within which event and condition determination based on sensor data may be implemented. The architecture depicted in FIG. 10 is segmented into four groups: users 950, radio access network 960, core network 970, and interconnect network 980. Users 950 comprise a plurality of end users. Note, device 912 is referred to as a mobile subscriber in the description of network shown in FIG. 10. In an example embodiment, the device depicted as mobile subscriber 912 comprises a communications device (e.g., intended recipient(s) 32, communications device 80, WTRU 102). Radio access network 960 may comprise a plurality of base station subsystems such as BSSs 962, which include BTSs 964 and BSCs 966. Core network 970 may comprise a host of various network elements. As illustrated in FIG. 10, core network 970 may comprise Mobile Switching Center (“MSC”) 971, Service Control Point (“SCP”) 972, gateway MSC 973, SGSN 976, Home Location Register (“HLR”) 974, Authentication Center (“AuC”) 975, Domain Name Server (“DNS”) 977, and GGSN 978. Interconnect network 980 also comprises a host of various networks and other network elements. As illustrated in FIG. 10, interconnect network 980 comprises Public Switched Telephone Network (“PSTN”) 982, Fixed-End System (“FES”) or Internet 984, firewall 988, and Corporate Network 989.

A mobile switching center can be connected to a large number of base station controllers. At MSC 971, for instance, depending on the type of traffic, the traffic may be separated in that voice may be sent to Public Switched Telephone Network (“PSTN”) 982 through Gateway MSC (“GMSC”) 973, and/or data may be sent to SGSN 976, which then sends the data traffic to GGSN 978 for further forwarding.

When MSC 971 receives call traffic, for example, from BSC 966, it sends a query to a database hosted by SCP 972. The SCP 972 processes the request and issues a response to MSC 971 so that it may continue call processing as appropriate.

The HLR 974 is a centralized database for users to register to the GPRS network. HLR 974 stores static information about the subscribers such as the International Mobile Subscriber Identity (“IMSI”), subscribed services, and a key for authenticating the subscriber. HLR 974 also stores dynamic subscriber information such as the current location of the mobile subscriber. Associated with HLR 974 is AuC 975. AuC 975 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 10, when mobile subscriber 912 initiates the attach process by turning on the network capabilities of the mobile device, an attach request is sent by mobile subscriber 912 to SGSN 976. The SGSN 976 queries another SGSN, to which mobile subscriber 912 was attached before, for the identity of mobile subscriber 912. Upon receiving the identity of mobile subscriber 912 from the other SGSN, SGSN 976 requests more information from mobile subscriber 912. This information is used to authenticate mobile subscriber 912 to SGSN 976 by HLR 974. Once verified, SGSN 976 sends a location update to HLR 974 indicating the change of location to a new SGSN, in this case SGSN 976. HLR 974 notifies the old SGSN, to which mobile subscriber 912 was attached before, to cancel the location process for mobile subscriber 912. HLR 974 then notifies SGSN 976 that the location update has been performed. At this time, SGSN 976 sends an Attach Accept message to mobile subscriber 912, which in turn sends an Attach Complete message to SGSN 976.

After attaching itself with the network, mobile subscriber 912 then goes through the authentication process. In the authentication process, SGSN 976 sends the authentication information to HLR 974, which sends information back to SGSN 976 based on the user profile that was part of the user's initial setup. The SGSN 976 then sends a request for authentication and ciphering to mobile subscriber 912. The mobile subscriber 912 uses an algorithm to send the user identification (ID) and password to SGSN 976. The SGSN 976 uses the same algorithm and compares the result. If a match occurs, SGSN 976 authenticates mobile subscriber 912.

Next, the mobile subscriber 912 establishes a user session with the destination network, corporate network 989, by going through a Packet Data Protocol (“PDP”) activation process. Briefly, in the process, mobile subscriber 912 requests access to the Access Point Name (“APN”), for example, UPS.com, and SGSN 976 receives the activation request from mobile subscriber 912. SGSN 976 then initiates a Domain Name Service (“DNS”) query to learn which GGSN node has access to the UPS.com APN. The DNS query is sent to the DNS server within the core network 970, such as DNS 977, which is provisioned to map to one or more GGSN nodes in the core network 970. Based on the APN, the mapped GGSN 978 can access the requested corporate network 989. The SGSN 976 then sends to GGSN 978 a Create Packet Data Protocol (“PDP”) Context Request message that contains necessary information. The GGSN 978 sends a Create PDP Context Response message to SGSN 976, which then sends an Activate PDP Context Accept message to mobile subscriber 912.

Once activated, data packets of the call made by mobile subscriber 912 can then go through radio access network 960, core network 970, and interconnect network 980, in a particular fixed-end system or Internet 984 and firewall 988, to reach corporate network 989.

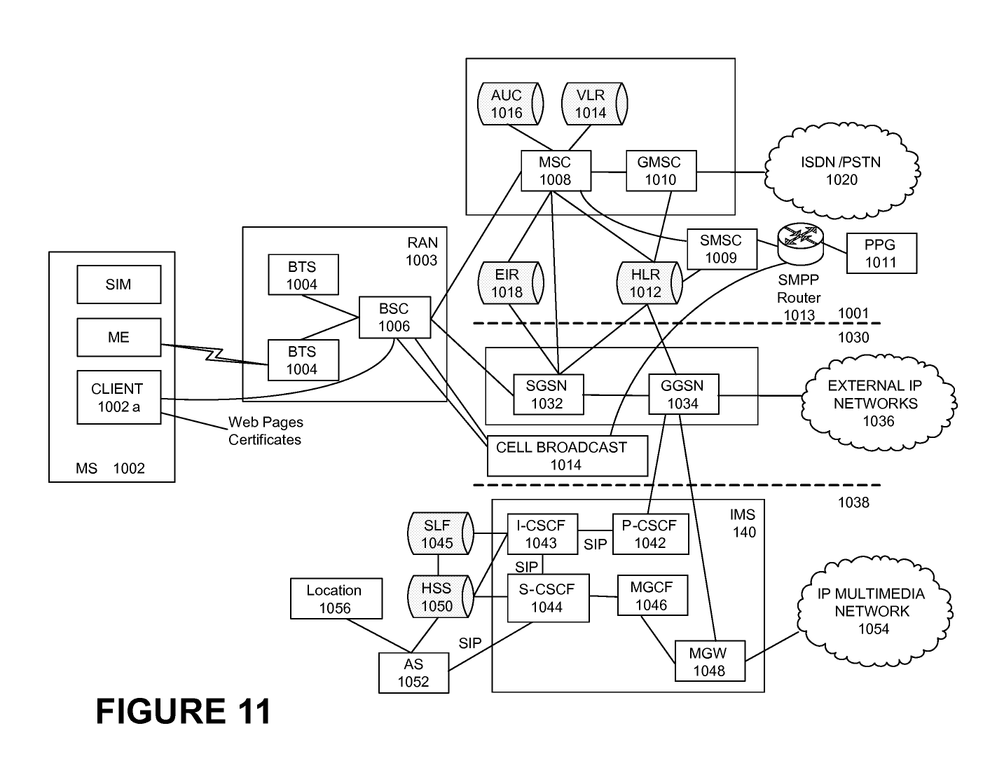

FIG. 11 illustrates an example block diagram view of a GSM/GPRS/IP multimedia network architecture within which event and condition determination based on sensor data may be implemented. As illustrated, the architecture of FIG. 11 includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. Thus, the GMSC 1010 provides interworking functionality with external networks.

The HLR 1012 is a database that contains administrative information regarding each subscriber registered in a corresponding GSM network. The HLR 1012 also contains the current location of each MS. The VLR 1014 is a database that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (i.e., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 14 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043, forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

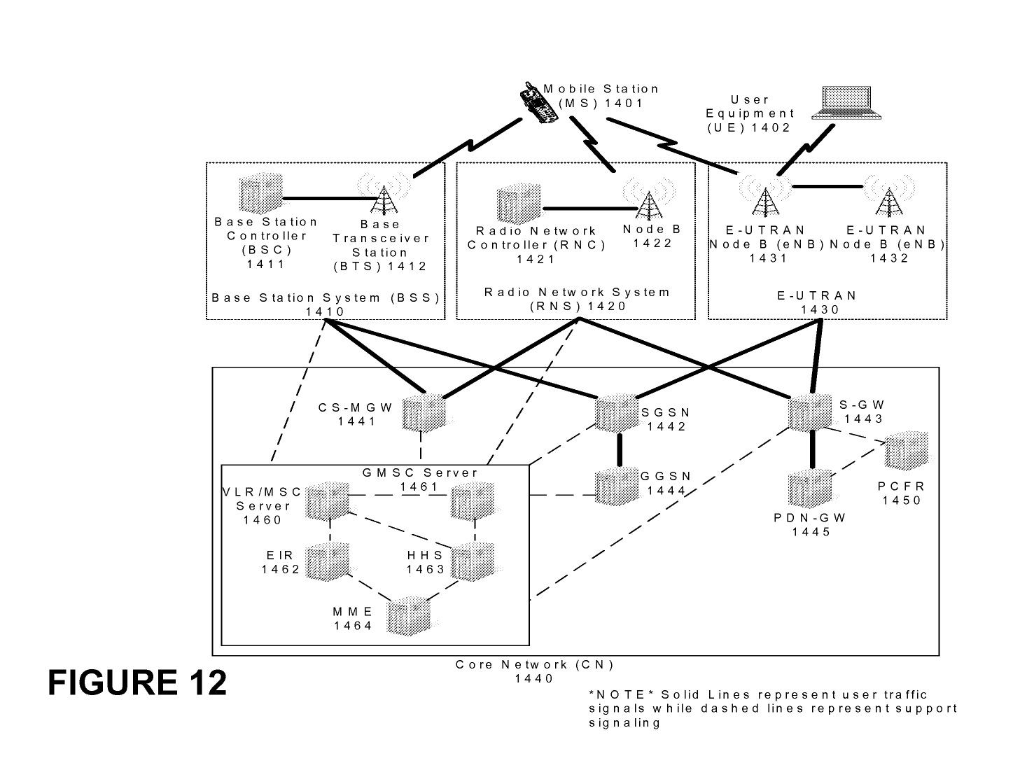

FIG. 12 illustrates a PLMN block diagram view of an example architecture in which event and condition determination based on sensor data may be incorporated. Mobile Station (MS) 1401 is the physical equipment used by the PLMN subscriber. In one illustrative embodiment, communications device 200 may serve as Mobile Station 1401. Mobile Station 1401 may be one of, but not limited to, a cellular telephone, a cellular telephone in combination with another electronic device or any other wireless mobile communication device.

Mobile Station 1401 may communicate wirelessly with Base Station System (BSS) 1410. BSS 1410 contains a Base Station Controller (BSC) 1411 and a Base Transceiver Station (BTS) 1412. BSS 1410 may include a single BSC 1411/BTS 1412 pair (Base Station) or a system of BSC/BTS pairs which are part of a larger network. BSS 1410 is responsible for communicating with Mobile Station 1401 and may support one or more cells. BSS 1410 is responsible for handling cellular traffic and signaling between Mobile Station 1401 and Core Network 1440. Typically, BSS 1410 performs functions that include, but are not limited to, digital conversion of speech channels, allocation of channels to mobile devices, paging, and transmission/reception of cellular signals.

Additionally, Mobile Station 1401 may communicate wirelessly with Radio Network System (RNS) 1420. RNS 1420 contains a Radio Network Controller (RNC) 1421 and one or more Node(s) B 1422. RNS 1420 may support one or more cells. RNS 1420 may also include one or more RNC 1421/Node B 1422 pairs or alternatively a single RNC 1421 may manage multiple Nodes B 1422. RNS 1420 is responsible for communicating with Mobile Station 1401 in its geographically defined area. RNC 1421 is responsible for controlling the Node(s) B 1422 that are connected to it and is a control element in a UMTS radio access network. RNC 1421 performs functions such as, but not limited to, load control, packet scheduling, handover control, security functions, as well as controlling Mobile Station 1401's access to the Core Network (CN) 1440.

The evolved UMTS Terrestrial Radio Access Network (E-UTRAN) 1430 is a radio access network that provides wireless data communications for Mobile Station 1401 and User Equipment 1402. E-UTRAN 1430 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1430 may include of series of logical network components such as E-UTRAN Node B (eNB) 1431 and E-UTRAN Node B (eNB) 1432. E-UTRAN 1430 may contain one or more eNBs. User Equipment 1402 may be any user device capable of connecting to E-UTRAN 1430 including, but not limited to, a personal computer, laptop, mobile device, wireless router, or other device capable of wireless connectivity to E-UTRAN 1430. The improved performance of the E-UTRAN 1430 relative to a typical UMTS network allows for increased bandwidth, spectral efficiency, and functionality including, but not limited to, voice, high-speed applications, large data transfer and IPTV, while still allowing for full mobility.

An example embodiment of a mobile data and communication service that may be implemented in the PLMN architecture described in FIG. 12 is the Enhanced Data rates for GSM Evolution (EDGE). EDGE is an enhancement for GPRS networks that implements an improved signal modulation scheme known as 8-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1401 may communicate with any or all of BSS 1410, RNS 1420, or E-UTRAN 1430. In a illustrative system, each of BSS 1410, RNS 1420, and E-UTRAN 1430 may provide Mobile Station 1401 with access to Core Network 1440. The Core Network 1440 may include of a series of devices that route data and communications between end users. Core Network 1440 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched—Media Gateway Function (CS-MGW) 1441 is part of Core Network 1440, and interacts with Visitor Location Register (VLR) and Mobile-Services Switching Center (MSC) Server 1460 and Gateway MSC Server 1461 in order to facilitate Core Network 1440 resource control in the CS domain. Functions of CS-MGW 1441 include, but are not limited to, media conversion, bearer control, payload processing and other mobile network processing such as handover or anchoring. CS-MGW 1440 may receive connections to Mobile Station 1401 through BSS 1410, RNS 1420 or both.

Serving GPRS Support Node (SGSN) 1442 stores subscriber data regarding Mobile Station 1401 in order to facilitate network functionality. SGSN 1442 may store subscription information such as, but not limited to, the International Mobile Subscriber Identity (IMSI), temporary identities, or Packet Data Protocol (PDP) addresses. SGSN 1442 may also store location information such as, but not limited to, the Gateway GPRS Support Node (GGSN) 1444 address for each GGSN where an active PDP exists. GGSN 1444 may implement a location register function to store subscriber data it receives from SGSN 1442 such as subscription or location information.

Serving Gateway (S-GW) 1443 is an interface which provides connectivity between E-UTRAN 1430 and Core Network 1440. Functions of S-GW 1443 include, but are not limited to, packet routing, packet forwarding, transport level packet processing, event reporting to Policy and Charging Rules Function (PCRF) 1450, and mobility anchoring for inter-network mobility. PCRF 1450 uses information gathered from S-GW 1443, as well as other sources, to make applicable policy and charging decisions related to data flows, network resources and other network administration functions. Packet Data Network Gateway (PDN-GW) 1445 may provide user-to-services connectivity functionality including, but not limited to, network-wide mobility anchoring, bearer session anchoring and control, and IP address allocation for PS domain connections.

Home Subscriber Server (HSS) 1463 is a database for user information, and stores subscription data regarding Mobile Station 1401 or User Equipment 1402 for handling calls or data sessions. Networks may contain one HSS 1463 or more if additional resources are required. Example data stored by HSS 1463 include, but is not limited to, user identification, numbering and addressing information, security information, or location information. HSS 1463 may also provide call or session establishment procedures in both the PS and CS domains.

The VLR/MSC Server 1460 provides user location functionality. When Mobile Station 1401 enters a new network location, it begins a registration procedure. A MSC Server for that location transfers the location information to the VLR for the area. A VLR and MSC Server may be located in the same computing environment, as is shown by VLR/MSC Server 1460, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for Mobile Station 1401 registration or procedures for handover of Mobile Station 1401 to a different section of the Core Network 1440. GMSC Server 1461 may serve as a connection to alternate GMSC Servers for other mobile stations in larger networks.

Equipment Identity Register (EIR) 1462 is a logical element which may store the International Mobile Equipment Identities (IMEI) for Mobile Station 1401. In a typical embodiment, user equipment may be classified as either “white listed” or “black listed” depending on its status in the network. In one embodiment, if Mobile Station 1401 is stolen and put to use by an unauthorized user, it may be registered as “black listed” in EIR 1462, preventing its use on the network. Mobility Management Entity (MME) 1464 is a control node which may track Mobile Station 1401 or User Equipment 1402 if the devices are idle. Additional functionality may include the ability of MME 1464 to contact an idle Mobile Station 1401 or User Equipment 1402 if retransmission of a previous session is required.

While example embodiments of event and condition determination based on sensor data have been described in connection with various computing devices/processors, the underlying concepts may be applied to any computing device, processor, and/or system capable of implementing event and condition determination based on sensor data. The various techniques described herein may be implemented in connection with hardware or software or, where appropriate, with a combination of both. Thus, the methods and apparatuses of message language conversion may be implemented, or certain aspects or portions thereof, may take the form of program code (i.e., instructions) embodied in tangible storage media having a tangible physical structure. Examples of tangible storage media include floppy diskettes, CD-ROMs, DVDs, hard drives, or any other tangible machine-readable storage medium (computer-readable storage medium). Thus, a computer-readable storage medium is not a transient signal per se. Further, a computer-readable storage medium is not a propagating signal per se. When the program code is loaded into and executed by a machine, such as a computer, the machine becomes an apparatus for implementing event and condition determination based on sensor data. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for using and implementing event and condition determination based on sensor data also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing event and condition determination based on sensor data. When implemented on a general-purpose processor, the program code may combine with the processor to provide a unique apparatus that operates to invoke the functionality of message language conversion.

While event and condition determination based on sensor data has been described in connection with the various embodiments of the various figures, it is to be understood that other similar embodiments may be used or modifications and additions may be made to the described embodiments for implementing event and condition determination based on sensor data without deviating therefrom. For example, one skilled in the art will recognize that event and condition determination based on sensor data as described in the instant application may apply to any environment, whether wired or wireless, and may be applied to any number of such devices connected via a communications network and interacting across the network. Therefore, event and condition determination based on sensor data should not be limited to any single embodiment, but rather should be construed in breadth and scope in accordance with the appended claims.

What is claimed:

1. A device comprising:
a processor; and
memory coupled to the processor, the memory comprising executable instructions that when executed by the processor cause the processor to effectuate operations comprising:
receiving vehicle sensor data from a plurality of vehicles;
aggregating the received vehicle sensor data;
determining an event associated with the aggregated data; and
providing an indication of the event.

2. The device of claim 1, the operations further comprising:
analyzing the aggregated data to determine a location of the event.

3. The device of claim 1, wherein:
a vehicle of the plurality of vehicles comprises a land vehicle.

4. The device of claim 1, wherein:
a vehicle of the plurality of vehicles comprises a marine vehicle.

5. The device of claim 1, wherein:
a vehicle of the plurality of vehicles comprises an air vehicle.

6. The device of claim 1, wherein:
the sensor data is indicative of a maneuver of a vehicle of the plurality of vehicles.

7. The device of claim 1, wherein:
the sensor data comprises a rapid transient change in tire pressure of a tire of a vehicle of the plurality of vehicles; and
the event comprise a disruption in a surface of a roadway.

8. The device of claim 1, wherein:
the indication of the event is haptically provided.

9. The device of claim 1, wherein:
the indication of the event is haptically provided via a steering wheel of the vehicle.

10. The device of claim 1, wherein:
the indication of the event is haptically provided via a seat of a vehicle of the plurality of vehicles.

11. The device of claim 1, wherein:
the indication of the event is audibly provided via an acoustic transmitter of a vehicle of the plurality of vehicles.

12. The device of claim 1, wherein:
the device comprises a mobile communications device.

13. The device of claim 1, wherein:
the device comprises an entity embedded in a vehicle of the plurality of vehicles.

14. The device of claim 1, wherein:
the device comprises a network entity.

15. A computer-readable storage medium comprising executable instructions that when executed by a processor cause the processor to effectuate operations comprising:
receiving vehicle sensor data from a plurality of vehicles;
aggregating the received vehicle sensor data;
determining an event associated with the aggregated data; and
providing an indication of the event.

16. The computer-readable storage medium of claim 15, the operation further comprising:
analyzing the aggregated data to determine a location of the event.

17. The computer-readable storage medium of claim 15, wherein:
the sensor data is indicative of a maneuver of the vehicle.

18. The computer-readable storage medium of claim 15, wherein:
the sensor data comprises a rapid transient change in tire pressure of a tire of the vehicle; and
the event comprise a disruption in a surface of a roadway.

19. The computer-readable storage medium of claim 15, wherein:
the indication of the event is haptically provided.

20. A method comprising:
receiving vehicle sensor data from a plurality of vehicles;
aggregating the received vehicle sensor data;
determining an event associated with the aggregated data; and
providing an indication of the event.
